(19) United States
(12) Patent Application Publication
(10) Pub. No.: US 2025/0350534 A1
(43) Pub. Date: Nov. 13, 2025

(54) A System and Method for Training a Federated Learning Model Using Network Data

(71) Applicant: Telefonaktiebolaget LM Ericsson (publ), Stockholm (SE)

(72) Inventors: Andreas Johnsson, Uppsala (SE); Hannes Larsson, Solna (SE); Jalil Taghia, Stockholm (SE); Farnaz Moradi, Bromma (SE); Masoumeh Ebrahimi, Solna (SE); Xiaoyu Lan, Täby (SE)

(21) Appl. No.: 18/868,211

(22) PCT Filed: May 25, 2022
(86) PCT No.: PCT/SE2022/050506

§ 371 Date: Nov. 22, 2024

(51) Int. Cl. H04L 41/12; H04L 41/0893; H04L 41/16

(52) U.S. Cl. CPC H04L 41/12; H04L 41/0893; H04L 41/16

(57) ABSTRACT

A system (200), a first network node (240), a method, a computer program and a computer program product for training of a Federated Learning. FL, model is disclosed. The system comprises network nodes. One of the network nodes is a first network node. Each network node has access to a part of the network data. The system obtains network information and determines groups of network nodes and assigns each network node to one of the determined groups based on the network information, each determined group of network nodes comprising at least two network nodes. For each of the groups, the system appoints a second network node from among the at least two network nodes, informs the at least two network nodes about the appointed second network node and trains an FL model using the parts of the network data accessible by the at least two network nodes.

### TECHNICAL FIELD

The invention relates to a system, a first network node, a method performed by the first network node, a method performed by the system, and a corresponding computer program executed by the first network node and the system, and a corresponding computer program product for the first network node and the system.

### BACKGROUND

Management of telecommunication systems is challenging due to component and service complexity, heterogeneity, scale, and dynamicity. In case of management of a distributed network, a Machine Learning (ML) model is oftentimes trained in a distributed manner to exploit and mitigate the possibilities and challenges of the distributed network.

Federated Learning (FL) or classical FL is an ML technique wherein the ML model trains an algorithm across multiple decentralized edge devices or servers holding local data samples, without exchanging them. An important aspect of FL is communication cost. FL can be used in ad-hoc networks and IoT networks. Training ML models in FL takes place collaboratively. An FL system is a system that employs FL for training of a data model and the FL system comprises a leader node and worker nodes. Learning in the FL system starts with a leader node initializing a global model with a fixed architecture and sending the global model to all workers in the system. Models in the FL system are trained in the workers for a plurality of epochs. Then, updates from each of the models in the FL system are sent back to the leader where they are aggregated (commonly, averaged but other techniques may be used) and then sent back to the workers. This process of initializing a global model, training the model in the workers, sending updates of the trained models to the leader, averaging the model updates and then eventually sending the model updates back to the workers leads to a collaboratively trained model that combines knowledge from all the workers.

FL consumes network resources, especially if the worker nodes are located far apart in a network. Here, the consumption of network resources corresponds to the utilization of one or many links. In the case of a large distance between two worker nodes, multiple links are traversed, and thus more network resources are consumed. FL is, in general, not designed to account for restrictions and requirements of a distributed network infrastructure that may have limitations in, for example, network capacity, link capacity, complexity, etc. Large federations for FL come with multiple problems such as a risk for longer convergence in training time, larger network overhead from neural-network weight updates across the network and establishing trust among a large group of nodes.

US 2021/0365841 A1 discloses a method and apparatus for implementing FL. In the disclosure, a set of updates is obtained, wherein each update represents a respective difference between a global model and a respective local model. A set of weighting coefficients is calculated, to be used in calculating a weighted average by performing multi-objective optimization towards a Pareto-stationary solution across the set of updates. The weighted average is calculated by applying the set of weighting coefficients to the set of updates, and the global model is updated by adding the weighted average to the global model.

In existing FL systems, an objective function for creation of a hierarchy is not necessarily aligned with an objective of the FL system such as minimizing communication cost, and indeed in typical applications, it only indirectly relates to the objective of FL system. Additionally, there is no data-driven mechanism for creation and inclusion of novel knowledge. Similarity-based criteria used in such FL techniques may result in too homogenous clusters which lack diversity. This can especially become problematic in heterogenous FL use-cases, such as in the case of non-independent and identically distributed (IID) FL.

The method for using diversity as a criterion for source selection in transfer learning for FL does not address the problems regarding how we can group workers into sub-federations based on network topology and other parameters in order to reduce network footprint, network utilization or network overhead while keeping data in federations of the FL system good enough for the distributed ML model to learn.

WO 2022/060284 A1 discloses a method that uses diversity for selecting sources in machine learning. The document suggests using diversity of a source data set as a selection criterion for selecting a source model in transfer learning, in contrast to the more commonly used similarity between a source and a target domain.

### SUMMARY

An object of the invention is to improve network efficiency.

This and other objects are met by means of different aspects of the invention, as defined by the independent claims.

According to a first aspect, a system for training a Federated Learning, FL, model, using network data is provided. The system comprises network nodes of which one of the network nodes is a first network node. Each network node of the network nodes has access to a part of the network data. The system is adapted/configured/operative to obtain by the first network node, network information, the network information comprising: a list of the network nodes, topological position information of the network nodes, and, for each network node, a statistical property of the part of the network data accessible by the network node. The system is configured to determine groups of network nodes and assign each network node of the network nodes to one of the determined groups based on the network information obtained by the first network node. Each determined group of network nodes comprising at least two network nodes. The system is configured to appoint a second network node as group leader from among the at least two network nodes, inform the at least two network nodes about the appointed second network node and train an FL model using the part of the network data accessible by the at least two network nodes for each of the determined groups.

Hereby is achieved that, data exchange between the network nodes is reduced. Another achievement of the invention is that the overall network overhead in a network is reduced. An achievement of the invention herein is that the network utilization is reduced, and efficiency of the network is increased. Another notable achievement is that footprint of the network is reduced. Thus, ensuring that CO2 footprint caused due to data exchange between network nodes in classical FL is reduced or minimized. Hence, another object of the invention is to reduce CO2 footprint in a network. Also, an achievement of the invention herein is reducing the chance of packet drop due to network congestion.

According to an embodiment, the system is configured to appoint the second network node based on the topological position information of the at least two network nodes for each determined group. Hereby is achieved that, the second network node for each determined group may be appointed to reduce or minimize communication costs between the network nodes and the first network node.

According to an embodiment, a network node assigned to a determined group is configured to send a model update of the trained FL model to the second network node of the determined group. Hereby is achieved that, utilization of a communication link between the first network node and any other network node is reduced. Thereby, reducing the chance of packet drop due to link congestion.

According to an embodiment, the second network node in the group is configured to process the model update obtained from the network node to produce an output. Hereby is achieved that, processing load on the first network node is reduced. Thereby, the first network node is not overwhelmed.

According to an embodiment, the system is configured to obtain at the first network node, the output from the second network node.

According to an embodiment, a number of network nodes in a group is different than a number of network nodes in another group.

According to an embodiment, a number of network nodes in a group is the same as a number of network nodes in another group.

According to an embodiment, a number of network nodes in each group is the same. Hereby, is achieved that the second network node in each group has similar number of links and loads to process. Thereby, reducing complexity of the FL system. 15 According to an embodiment, a value of the statistical property of the parts of the network data accessible by the network nodes is with a given range.

According to an embodiment, a value of the statistical property of the parts of the network data accessible by the network nodes is different in the groups.

According to an embodiment, the statistical property of the parts of the network data accessible by the network nodes comprises a marginal property. Hereby is achieved that built-in robustness of the system is increased in case the system is a heterogenous system.

According to an embodiment, the statistical property of the parts of the network data accessible by the network nodes comprises a conditional property.

According to an embodiment, the network information further comprises one or more of: a network topology information; network resources; required Quality of Service, QOS; link utilization, latency between the network nodes; capacity between the network nodes; proximity of the network nodes. Hereby, is achieved that the first network node the second network node for each group are selected with due consideration to the FL system. Thereby, reducing the network overhead.

According to an embodiment, the system is adapted to set a constraint and wherein the groups are determined using the constraint.

According to an embodiment, the constraint comprises one of more of a statistical property of the parts of the network data; a sum of number of hops between the network nodes.

According to an embodiment, the constraint comprises one or more of a network computational profile and a network overhead.

According to an embodiment, the first network node obtains a part of the network information from a network management node.

According to an embodiment, the first network node is placed in the network management node. Hereby, is achieved that the complexity of the FL system is reduced.

According to a second aspect, a first network node adapted for enabling training of an FL model using network data is provided wherein the first network node is adapted to be a part of a system comprising network nodes. Each network node of the network nodes has access to a part of the network data. The first network node is adapted to obtain network information comprising a list of the network nodes, topological position of the network nodes, and, for each network node, a statistical property of the part of the network data accessible by the network node. Further, the first network node is adapted to determine groups of network nodes and assign each network node to one of the determined groups based on the network information, each determined group of network nodes comprising at least two network nodes. Furthermore, the first network node is adapted to appoint a second network node as group leader from among the at least two network nodes, inform the at least two network nodes about the appointed second network node and participate in training of an FL model using the parts of the network data accessible by the at least two network nodes for each of the determined groups.

According to an embodiment, the first network node is adapted to appoint the appointed second network node based on the topological position information of the at least two network nodes for each determined group.

According to an embodiment, the first network node is adapted to enable the appointed second network node of a determined group to obtain a model update of the trained FL model from a network node assigned to the determined group.

According to an embodiment, the first network node is adapted to enable the appointed second network node to process the model update obtained from the network node to produce an output.

According to an embodiment, the first network node is adapted to obtain the output from the second network node.

According to an embodiment, a number of network nodes in a group is different than a number of network nodes in another group.

According to an embodiment, a number of network nodes in a group is the same as a number of network nodes in another group.

According to an embodiment, a number of network nodes in each group is the same.

According to an embodiment, a value of the statistical property of the parts of the network data accessible by the network nodes is substantially the same.

According to an embodiment, a value of the statistical property of the parts of the network data accessible by the network nodes is different in the groups.

According to an embodiment, the statistical property of the parts of the network data accessible by the network nodes comprises a marginal property.

According to an embodiment, the statistical property of the parts of the network data accessible by the network nodes comprises a conditional property.

According to an embodiment, the network information further comprises one or more of: a network topology information; network resources; required Quality of Service, QoS; link utilization, latency between the network nodes; capacity between the network nodes; proximity of the network nodes.

According to an embodiment, the first network node is adapted to set a constraint. The groups are determined using the constraint.

According to an embodiment, the constraint comprises one of more of a statistical property of the parts of the network data; a sum of number of hops between the network nodes.

According to an embodiment, the constraint comprises one or more of: a network computational profile and a network overhead.

According to an embodiment, a part of the network information is obtained from a network management node.

According to an embodiment, the first network node is adapted to be placed in the network management node.

According to a third aspect, a method for training a Federated Learning, FL, model using network data, in a system comprising network nodes of which one of the network nodes is a first network node is provided. Each network node having access to a part of the network data. The method comprises obtaining by the first network node, network information wherein the network information comprises: a list of the network nodes, topological position information of the network nodes, and, for each network node, a statistical property of the part of the network data accessible by the network node. Further, the method comprises determining groups of network nodes and assigning each network node to one of the determined groups based on the network information, each determined group comprising at least two network nodes. Furthermore, the method comprises appointing a second network node as group leader from among the at least two network nodes, informing the at least two network nodes about the appointed second network node and training an FL model using the parts of the network data accessible by the at least two network nodes for each of the determined groups.

According to an embodiment, the method comprises appointing the second network node based on the topological position information of the at least two network nodes for each determined group.

According to an embodiment, the method comprises sending a model update of the trained FL model from a network node assigned to a determined group to the second network node.

According to an embodiment, the method comprises processing the model update obtained from the network node to produce an output.

According to an embodiment, the method comprises receiving at the first network node, the output from the second network node.

According to an embodiment, a number of network nodes in a group is different than a number of network nodes in another group.

According to an embodiment, a number of network nodes in a group is the same as a number of network nodes in another group.

According to an embodiment, a number of network nodes in each group is the same.

According to an embodiment, a value of the statistical property of the parts of the network data accessible by the network nodes is substantially the same.

According to an embodiment, a value of the statistical property of the parts of the network data accessible by the network nodes is different in the groups.

According to an embodiment, the statistical property of the parts of the network data accessible by the network nodes comprises a marginal property.

According to an embodiment, the statistical property of the parts of the network data accessible by the network nodes comprises a conditional property.

According to an embodiment, the network information further comprises one or more of: a network topology information; network resources; required Quality of Service, QoS; link utilization, latency and capacity between the network nodes; and proximity of the network nodes.

According to an embodiment, the method comprises setting a constraint. The groups are determined using the constraint.

According to an embodiment, the constraint comprises one of more of a statistical property of the parts of the network data; a sum of number of hops between the network nodes.

According to an embodiment, the constraint comprises one or more of: a network computational profile and a network overhead.

According to an embodiment, the method comprises obtaining a part of the network information at the first network node from a network management node.

According to an embodiment, the first network node is placed in the network management node.

According to a fourth aspect, a method for enabling training of an FL model with network data is provided. The method being performed by a first network node. The first network node adapted to be part of a system comprising network nodes of which one of the network nodes is the first network node. Each network node having access to a part of the network data. The method comprising obtaining network information comprising a list of the network nodes, topological position of the network nodes, and, for each network node, a statistical property of the part of the network data accessible by the network node. Further, the method comprising determining groups of network nodes and assigning each network node to one of the determined groups based on the network information, each determined group comprising at least two network nodes. Furthermore, appointing a second network node as group leader from among the at least two network nodes, informing the at least two network nodes about the appointed second network node and participating in training of an FL model using the parts of the network data accessible by the at least two network nodes for each of the determined groups.

According to an embodiment, the second network node for each determined group is appointed based on the topological position information of the at least two network nodes.

According to an embodiment, the method comprises enabling the second network node of a determined group to obtain a model update of the trained FL model from a network node assigned to the determined group.

According to an embodiment, the method comprises enabling the second network node to process the model update obtained from the network node to produce an output.

According to an embodiment, the method comprises obtaining the output from the second network node.

According to an embodiment, a number of network nodes in a group is different than a number of network nodes in another group.

According to an embodiment, a number of network nodes in a group is the same as a number of network nodes in another group.

According to an embodiment, a number of network nodes in each group is the same.

According to an embodiment, a value of the statistical property of the parts of the network data accessible by the network nodes is substantially the same.

According to an embodiment, a value of the statistical property of the parts of the network data accessible by the network nodes is different in the groups.

According to an embodiment, the statistical property of the parts of the network data accessible by the network nodes comprises a marginal property.

According to an embodiment, the statistical property of the parts of the network data accessible by the network nodes comprises a conditional property.

According to an embodiment, the network information further comprises one or more of: a network topology information; network resources; required Quality of Service, QOS; link utilization, latency between the network nodes; capacity between the network nodes; proximity of the network nodes.

According to an embodiment, the method comprises setting a constraint. The groups are determined using the constraint.

According to an embodiment, the constraint comprises one of more of a statistical property of the parts of the network data; a sum of number of hops between the network nodes.

According to an embodiment, the constraint comprises one or more of: a network computational profile and a network overhead.

According to an embodiment, the method comprises obtaining a part of the network information at the first network node from a network management node.

According to an embodiment, the first network node is placed in the network management node.

According to a fifth aspect, a system for training of a Federated Learning, FL, model, with network data is provided. The system comprises at least one processor and memory comprising instructions executable by the at least one processor. The instructions when executed by the at least one processor causes the system to perform the method according to the third aspect.

According to a sixth aspect, a computer program comprises instructions which, when executed by at least one processor of a system, causes the system to carry out the method according to the third aspect.

According to a seventh aspect, a computer program product stored on a non-transitory computer readable (storage or recording) medium is provided. The computer program product comprises instructions that, when executed by a processor of a system, cause the system to perform the method according to the third aspect.

According to an eight aspect, a first network node for training of a Federated Learning, FL, model, with network data is provided. The first network node comprises at least one processor and memory comprising instructions executable by the at least one processor. The instructions when executed by the at least one processor, causes the first network node to perform the method according to the fourth aspect.

According to a ninth aspect, a computer program comprises instructions which, when executed by at least one processor of a first network node, causes the first network node to carry out the method according to the fourth aspect.

According to a tenth aspect, a computer program product stored on a non-transitory computer readable (storage or recording) medium is provided. The computer program product comprises instructions that, when executed by a processor of a system, cause the system to perform the method according to the fourth aspect.

In some embodiments, achievements of the invention are increasing scalability of the system by enabling large number of network nodes to participate and optimizing the system from end-to-end. Also, in some embodiments, the achievements of the invention are reduction in training time and reduction in the convergence time for the FL model.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates a FL system for a communication network according to a prior art.

FIG. 2A illustrates a system for a communication network, in accordance with an embodiment of the invention.

FIG. 2B illustrates a system for a communication network, in accordance with an embodiment of the invention.

FIG. 3A is a flowchart depicting embodiments of a method in a first network node for enabling training of a Federated Learning, FL, model using network data, in accordance with an embodiment of the invention.

FIG. 3B is a flowchart depicting embodiments of a method in a first network node, in accordance with an embodiment of the invention.

FIG. 4A is a flowchart depicting embodiments of a method in a system for training an FL model using network data, in accordance with an embodiment of the invention.

FIG. 4B is a flowchart depicting embodiments of a method in a system, in accordance with an embodiment of the invention.

FIG. 5 illustrates signaling in a system comprising network nodes, in accordance with an embodiment of the invention.

FIG. 6A illustrates an example of a first network node, in accordance with an embodiment of the invention.

FIG. 6B illustrates an example of a first network node, in accordance with an embodiment of the invention.

FIG. 7 illustrates an example of a first network node as implemented in accordance with an embodiment of the invention.

FIG. 8 illustrates a computer program product, in accordance with an embodiment of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

This invention describes a method for training a Federated Learning (FL) model using network data in a system. An objective of the invention is to reduce/minimize network overhead in a system employing FL methods or techniques. In other words, an objective of the invention is to reduce or minimize network overhead in an FL system. The network overhead is reduced by reducing training overhead caused due to sending and receiving model data among agents and leaders in the FL system. In other words, the network overhead is reduced by reducing the exchange of messages between agents and leaders in the FL system. Examples of the network are but not limited to a telecommunications network, a local area network, a wide area network, a vehicular communication network, an Internet of Things (IoT) network, a 3GPP based network, a non-3GPP network or a network comprising both 3GPP and non-3GPP components. Examples of network nodes in the network are but not limited to a 3GPP network node, a non-3GPP network node or any other node in any of the aforementioned network types. The network nodes specified herein may either be a user device such as a user equipment or a network device such as a base station. The network data may be any data in the network or any data accessible by (locally or remotely) or available in the network node.

The FL system comprises network nodes of which one of the network nodes is a first network node. The system is adapted/configured/operative to obtain network information by the first network node. Further, according to some embodiments, the system may be adapted to determine and create a “minimalistic federation” for training a Machine Learning (ML) model in a distributed and/or privacy-preserved manner. The minimalistic federation is determined based on network information of the FL system. The system is adapted to determine groups of network nodes wherein each of the groups is determined based on the network information obtained by the first network node. Each network node of the network nodes is assigned to one of the determined groups based on the obtained network information. The network information comprises a list of the network nodes, topological position information of the network nodes, and, for each network node, a statistical property of a part of the network data accessible by the network node. The network information may include additional information than those listed.

In order to form the determined groups, each network node is assigned to a group to either physically or logically place each network node in a group based on the network information obtained. Each determined group by the system comprises at least two network nodes. In other words, the network nodes are “re-arranged” and placed in the determined groups, on the basis of the network information. Within each of the determined groups, the system is adapted to appoint a second network node as group leader from among the at least two network nodes. The system is adapted to inform the at least two network nodes about the appointed second network node. The system is adapted to train an FL model using the parts of the network data accessible by the at least two network nodes for each of the determined groups. A network node in the network nodes may, in some cases, have access to all the network data as well. The network data itself may be any data that provides information about the network or any data that is accessible (logically or physically) by the network node.

Possible advantages of the invention are listed but not limited to enabling scalability to a large number of FL worker nodes/agents, reduction of communication cost in a system or a network, increasing built-in robustness in case of heterogenous FL systems and/or performing end-to-end optimization of the system. The number of FL worker nodes/agents may be greater than or equal to 4.

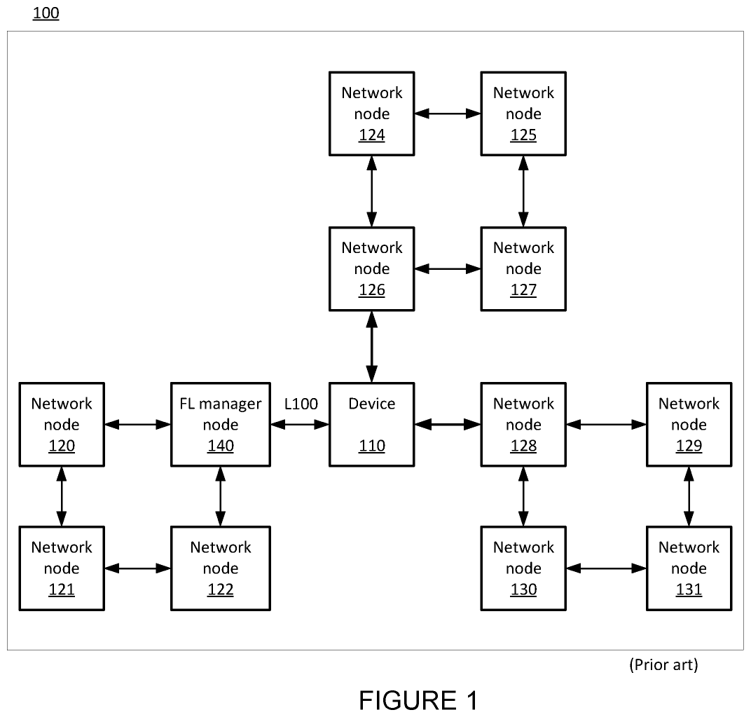

FIG. 1 illustrates an FL system 100 according to an example which is not part of the invention for a communication network comprising a device 110 and twelve network nodes 120-122, 124-131, 140. One of the twelve network nodes is an FL manager node 140. The network nodes 120-122 and the network node 140 which is also the FL manager node 140 communicate with the network nodes 124-127 and the network nodes 128-131 via the device 110. The device 110 may be any network switch or a network router. In other words, the device 110 may be any apparatus capable of forwarding data among network nodes. The device 110 may be capable of forwarding packets or frames in User Plane or Control Plane. In an example, the device 110 may be any forwarding node. The FL manager node 140 is configured to receive data from each network node either via a direct link/connection or via the device 110. In particular, the FL manager node receives, when training of a model is taking place, an output of the model training from each network node 120-122, 124-131, 140. In such a setup, there is the possibility that a link between the FL manager node and the device 110, for example link L100, chokes or becomes overloaded due to multiple input sources and/or a lack of bandwidth. The result of the link overloading may be packet loss and possible re-transmission of data. In case there is no link overloading, the FL manager node 140 receives the output of model training from each of the network nodes to perform rest of FL steps such as training and evaluating the model, parameter tuning and predictions. In case the FL manager node 140 receives and performs all the rest of the FL steps, the FL model takes a long time for training and convergence. Also, since each network node sends data to the FL manager node 140, the overall network overhead increases due to increased exchange of messages in the form of model updates between the network nodes and the FL manager node. Thus, several problems may exist in the traditional FL system such as link overloading, long convergence time, long training time, increased re-transmission of data, more network overhead, more resource consumption, and increased power consumption.

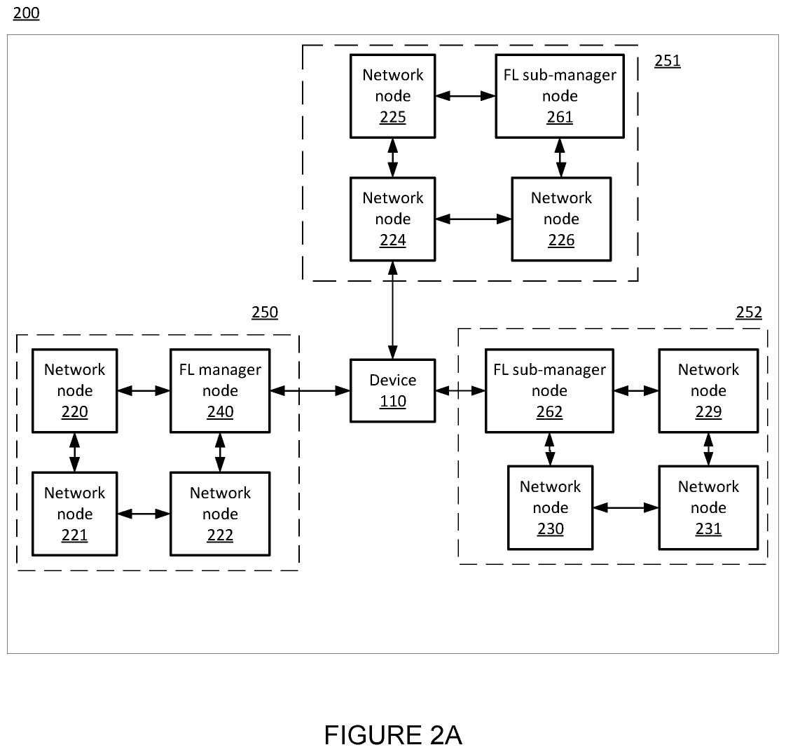

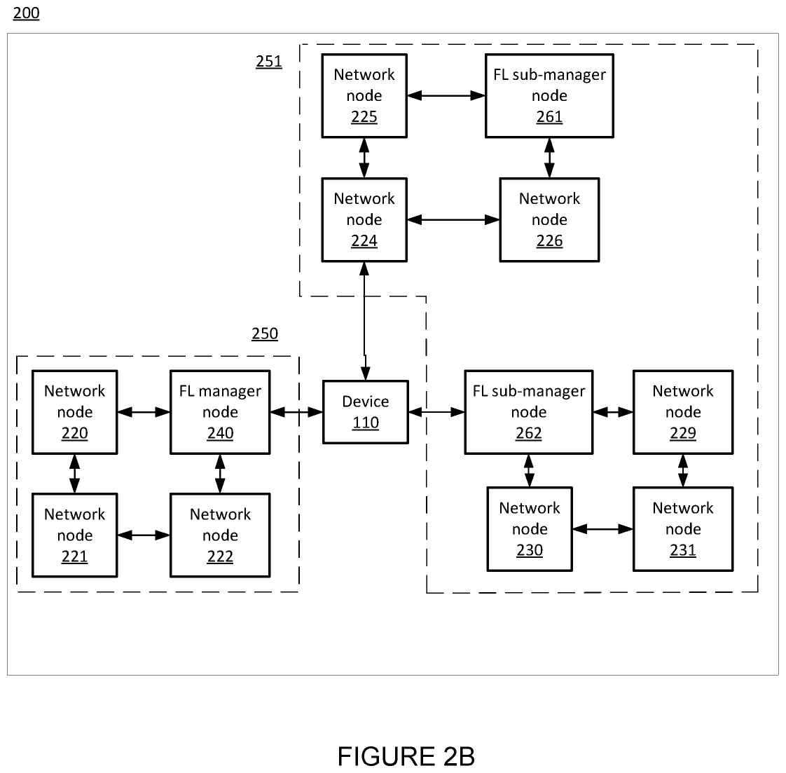

FIG. 2A illustrates a system 200 for training a FL model using network data as per an embodiment of the invention herein for a communication network comprising a device 110 and a certain number of network nodes, for example twelve nodes 220-222, 224-226, 229-231, 240, 261, 262. Although the embodiment shows twelve nodes, any number of nodes can be used in the embodiments of the invention. One of the network nodes, network node 240 is an FL manager node 240. The FL manager node 240 is alternatively called a first network node 240. In a step of the invention, the network nodes 220-222 and the FL manager node 240 communicate with network nodes 224-226, 261 and the network nodes 229-231, 262 via the device 110. The first network node 240 is configured/adapted/operative to obtain network information. In an embodiment, the network information is obtained from the network nodes 220-222, 224-226, 229-231, 240, 261, 262. In an embodiment, the network information may be obtained from a management node such as a Network Management System (NMS) or an Operations Support Subsystem (OSS). Each network node of the network nodes may access a part of the network data, or a part of the network data may be stored in a network node of the network nodes. In another embodiment, the network data may be communicated to the network nodes upon request by the network nodes or by the management node. The network information comprises a list of the network nodes 220-222, 224-226, 229-231, 240, 261, 262, topological position information of the network nodes 220-222, 224-226, 229-231, 240, 261, 262, and, for each network node, a statistical property of the part of the network data accessible by the first network node either via a direct link or via the device 110. The system 200 is further adapted to determine groups of the network nodes 220-222, 224-226, 229-231, 240, 261, 262 and assign each of the network nodes 220-222, 224-226, 229-231, 240, 261, 262 to the determined groups based on the network information obtained by the first network node 240. In an example, the determined groups is three, that is, there are three determined groups 250-252. Each determined group comprises at least two network nodes. All the network nodes 220-222, 224-226, 229-231, 240, 261, 262 are assigned to at least a group of the determined groups 250-252. For example, there are M network nodes, which are assigned to N groups, where M≥2N. In the FIG. 2A, the twelve network nodes have been assigned to three groups. In another example, size of the determined groups may be different. In other words, each of the determined groups may comprise a different number of network nodes. Further, the system 200 is adapted to appoint, in each of the determined groups, a second network node as group leader or FL sub-manager node from among the at least two network nodes. In this way, if there are N groups, N second network nodes are appointed, one second network node for each of the N group. The system 200 is adapted to inform the at least two network nodes in each group about the appointed second network node. For example, each network node in a group is aware of the identity of the second network node. In this case, group 250 comprises the network nodes 220-222, 224-226, 229-231, 240, 261, 262, wherein the network node 240 is the first network node 240; group 251 comprises the network nodes 224-226, 261, wherein the network node 261 is a second network node 261 of group 251; and group 252 comprises the network nodes 229-231, 262, wherein the network node 262 is the second network node 262 of group 252. The second network nodes 261, 262 are alternatively called FL sub-manager nodes 261, 262. Further, the system 200 is adapted to train an FL model using the parts of the network data accessible by the at least two network nodes for each of the groups 250-252. In such a setup, a link between the first network node 240 and the device 110 is unlikely to choke due to multiple input sources and a lack of bandwidth. This is achieved since number of data exchanges between the network nodes reduces considerably, especially in the link between the first network node and the device 110. Thereby, reducing the risk of choking of the link due to packet loss and re-transmission of data. Also, output of the FL model takes a shorter time for training and convergence as compared to the traditional FL system (prior art) due to a lower number of network nodes (or worker nodes) in the groups, which in this case are an individual federation each. Furthermore, the overall network overhead decreases due to reduced exchange of data in the form of model updates between the network nodes 220-222, 224-226, 229-231, 261, 262 and the first network node 240. Thus, several problems of the existing traditional FL system such as link overloading, long convergence time, long training time, increased re-transmission of data, more network overhead, more resource consumption, and increased power consumption are resolved by employing the system 200 as per an embodiment of the invention.

FIG. 2B illustrates a system 200 for training an FL model as per an embodiment of the invention herein for a communication network. In an example, the system 200 comprises a device 110 and twelve network nodes 220-222, 224-226, 229-231, 240, 261, 262. One of the twelve network nodes is an FL manager node 240. The FL manager node 240 is alternatively called a first network node 240. The network nodes 220-222 and the network node 240 which is also the FL manager node 240 communicate with network nodes 224-226, 261 and the network nodes 229-231, 262 via the device 110. The network information comprises a list of the network nodes 220-222, 224-226, 229-231, 240, 261, 262, topological position information of the network nodes 220-222, 224-226, 229-231, 240, 261, 262, and, for each network node, a statistical property of the part of the network data accessible by the first network node either via a direct link or via the device 110. The system 200 is further adapted to determine groups the network nodes 220-222, 224-226, 229-231, 240, 261, 262 and assign the network nodes 220-222, 224-226, 229-231, 240, 261, 262 to one the determined groups 250-251 based on the network information obtained by the first network node 240 as described in FIG. 2A. Optionally, the groups may be determined based a marginal property of the part of network data accessible by the network nodes 220-222, 224-226, 229-231, 240, 261, 262 such as diversity of data accessible by the network nodes 220-222, 224-226, 229-231, 240, 261, 262, each determined group comprising at least two network nodes. The second network node in each of the groups 250-251 is appointed as described in FIG. 2A. In an example, if the diversity of the data accessible by or stored in the network nodes 224-226, 229-231, 261, 262 is not sufficiently diverse, group 250 comprises the network nodes 220-222, 240, wherein the network node 240 is the first network node 240; and group 251 comprises the network nodes 224-226, 229-231, 261, 262, wherein the network node 261 is a second network node 261. In an example, if the network nodes are not sufficiently diverse, a bigger group may be formed with the network nodes to ensure a minimum threshold of diversity in the group. Similarly, in another example, if the network nodes are not sufficiently similar, a bigger group may be formed with the network nodes to ensure a minimum threshold of similarity in the group. The minimum threshold of similarity or diversity in a group may be in range of for example one or two standard deviation from a similarity/diversity average. The second network node 261 is alternatively called an FL sub-manager node 261. Further, the system 200 is adapted to train an FL model using the parts of the network data accessible by the at least two network nodes for each of the groups 250-251.

The network information comprises a list of the network nodes, topological position information of the network nodes, and, for each network node, a statistical property of a part of the network data accessible by the network node. The list of the network nodes refers to a list that enlists all the nodes in a given network. The list of the network nodes may comprise further information such as network node Identity (ID), Media Access Control (MAC) address and Internet Protocol (IP) address. The topological position information of the network nodes refers to either the physical and/or logical or virtual position of the list of network nodes in a network. The topological position information may also comprise position of a network node of the network nodes relative to another one of the network nodes. The network topological information may comprise information about overall architecture and positioning of the network nodes in a network. The topological information may comprise topology information of the entire network including interconnection information between different network nodes. The statistical property of a network node from the network nodes comprises statistics with respect to data possessed by or accessible by the network node or statistics with respect to data that the network node is adapted to collect. In an example, the statistical property of the network nodes may comprise a marginal statistical property such as diversity or a conditional statistical property such as similarity of the parts of the network data accessible by the network nodes. In other words, in an example, the statistical property of the network nodes may comprise a marginal statistical property such as diversity or a conditional statistical property such as similarity of a part of the network data accessible by each of the network nodes.

Also, the number of groups ‘N’ should be greater than or equal to 2. The optimization algorithm is performed with an objective to reduce network load, especially over links with lower network capacity/bandwidth.

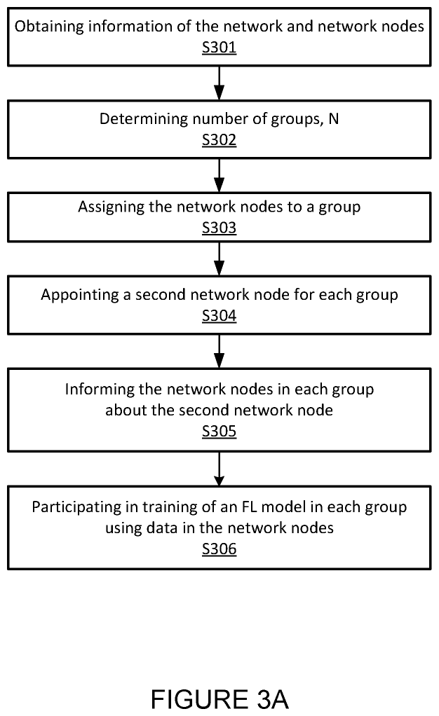

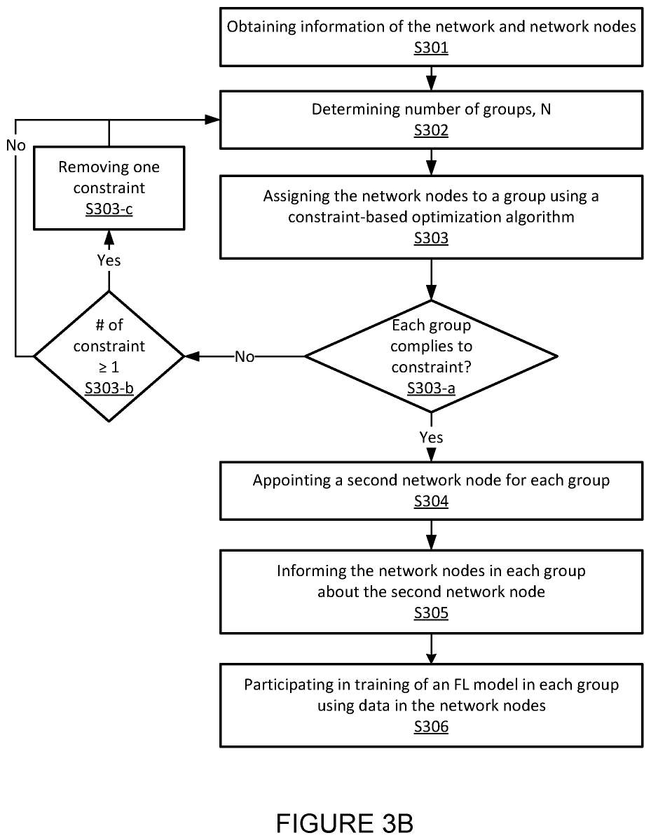

FIG. 3A is a flowchart depicting embodiments of a method in a first network node 240. According to an embodiment, a first network node 240 in a system 200 for enabling training of an FL model in a communication network, wherein the system comprises network nodes is provided. Each network node of the network nodes having access to a part of the network data. One of the network nodes is the first network node 240. The first network node 240 is alternatively called an FL manager node 240. The FL manager node 240 or the first network node 240 is adapted for enabling training of an FL model using network data.

In S301, the FL manager node 240 is configured/adapted/operative to obtain/receive network information comprising a list of the network nodes, topological position of the network nodes, and, for each network node, a statistical property of the part of the network data accessible by the network node. In an embodiment, two network nodes of the network nodes from S301 placed in two different base stations may have different topological positions since they might be placed either physically or logically apart. In an embodiment, the statistical property of the part of the network data in the network nodes from S301 may be either data diversity or data similarity.

In S302, the FL manager node 240 is configured to determine a number, N, of FL groups for the communication network based on the obtained/received network information. In an embodiment of S302, N may be a pre-configured value that is based on operator policies or user preferences wherein N is greater than or equal to 2.

In S303, the FL manager node 240 is configured to assign the network nodes to a group from the N groups based the network information.

In S304, the FL manager node 240 is configured to appoint a second network node or FL sub-manager node as group leader from among the at least two network nodes in each determined group. In an embodiment, the second network nodes or the FL sub-manager node are appointed based on the obtained network information. In an embodiment, the second network node is appointed based on the topological position information of the at least two network nodes in each of the determined groups. In an example, the second network node in a group from the N groups is appointed based on proximity to the first network node. In an example, the second network node is appointed based on reducing communication between the network nodes within a group of the N groups or within a system 200.

In S305, the FL manager node 240 is further configured to inform the network nodes in each group about the appointed FL sub-manager node. In an embodiment, information such as network node ID or an IP/MAC address that identifies the FL sub-manager node is sent to the network nodes in each group. Necessary security and privacy parameters such as encryption certificates are then exchanged between the FL sub-manager node and the network nodes of a particular group.

In S306, the FL manager node is configured to participate in training of an FL model in each group of the N groups using the parts of the network data accessible by the at least two network nodes wherein communication takes place between the network nodes and the FL sub-manager node of each determined group, and the FL sub-manager node of each determined group and the FL manager node 240.

FIG. 3B is a flowchart depicting embodiments of a method in an FL manager node 240 or a first network node 240. According to an embodiment, a first network node 240 in a system 200 for enabling training of an FL model in a communication network, wherein the system comprises network nodes is provided. Each network node of the network nodes having access to a part of the network data. One of the network nodes is a first network node 240. Steps S301 and S302 are performed as described for FIG. 3A.

In S303, the FL manager node 240 is configured to assign the network nodes to a group from N groups based the network information. In an embodiment of S303, the FL manager node 240 is configured to determine the number of groups and assign the network nodes to a group from the groups using a constraint-based optimization algorithm. In an embodiment, a constraint for the constraint-based optimization algorithm comprises one or more of proximity of the network nodes and the statistical properties of the data accessible by the network nodes. In an example, the constraint comprises one of more of a statistical property of the parts of the network data and a sum of number of hops between the network nodes. In an embodiment, the statistical property of the data accessible by the network nodes across different groups of the N groups should be approximately equal, that is, within a range of for example one or two standard deviation from a similarity or diversity average to ensure efficient learning across all the groups. In an embodiment, a number of network nodes in a group is different than a number of network nodes in another group. In other words, if we consider ‘P’ network nodes in a group ‘A’ then another group ‘B’ may have ‘Q’ network nodes. In an example, P>Q and in another example, Q>P. In an embodiment, a number of network nodes in a group is the same as a number of network nodes in another group. In other words, if group ‘C’ has ‘P’ network nodes, then group ‘D’ may also have ‘P’ network nodes. In an embodiment, a number of network nodes in each group is the same. In other words, if a system comprises groups ‘A’, ‘B’, ‘C’, then each of the groups has ‘P’ number of nodes. In an embodiment, the determination of the groups and assignment of the network nodes to each of the groups is based on a constraint-based algorithm. The constraint-based optimization algorithm may be applied to minimize network overhead in the network.

In S303-a, the FL manager node 240 is configured to perform a check to determine if each determined group of the N groups complies to a constraint if a constraint exists. In an embodiment, the constraint may be a diversity threshold of data accessible by a network node. In another example, the constraint may be a similarity threshold of data accessible by a network node. In an example, the diversity threshold and the similarity threshold may be a number between 0 to 1, wherein both 0 and 1 are included. In case the constraint is met, or no constraint exists, S304, S305, S306 as described for FIG. 3A is performed.

In S303-b, in case the constraint is not met, the FL manager node 240 is configured to compute a value representing a number of constraints of the optimization algorithm. In case the value is greater than or equal to 1, S303-c is performed wherein the FL manager node 240 is configured to remove a constraint before performing S302. If the value is less than 1 or 0, the FL manager node 240 is configured to perform S302. In an embodiment, removal of a constraint from the constraints is performed based on a rule-based engine where rules may be provided by an expert or learned using any statistical method. In an example, if diversity is a constraint, a threshold for the diversity of data or network data may be set. If the threshold for the diversity is not met, in an example, the constraint could be relaxed. In an example, number of hops between two network nodes is a constraint. In this case, if the number of hops is above a threshold, then the constraint is not met and hence, it may be relaxed. The FL manager node 240 is configured to perform steps S302 onward as described for FIG. 3A.

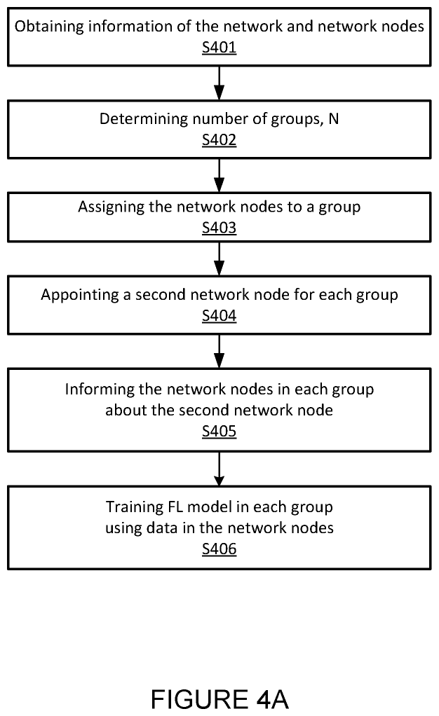

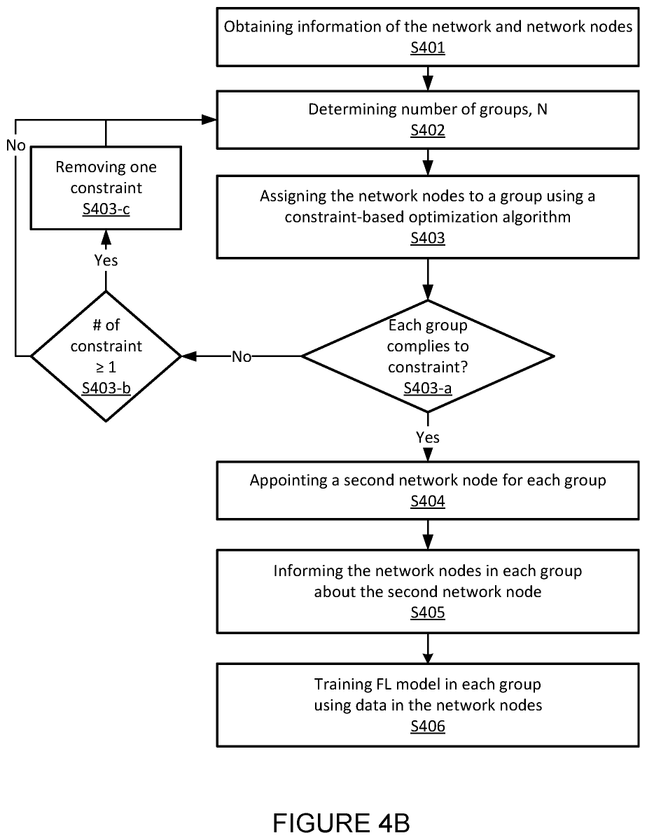

FIG. 4A is a flowchart depicting embodiments of a method for training a Federated Learning, FL, model using network data, in a system 200 comprising network nodes of which one of the network nodes is a first network node 240. The first node 240 is alternatively called the FL manager node 240.

In S401, the system 200 is configured/adapted to obtain by the first network node, network information comprising a list of the network nodes, topological position of the network nodes, and, for each network node, a statistical property of the part of the network data accessible by the network node.

In S402, the system 200 is configured to determine a number, N, of FL groups for the network based on the network information. Each the determined groups comprises at least two network nodes.

In S403, the system 200 is configured to assign the network nodes to each of the groups to a group from the N groups based on the network information.

In S404, the system 200 is configured to appoint a second network node or a FL sub-manager node as group leader from among the at least two network nodes in each determined group. In an embodiment, the second network nodes or the FL sub-manager node are appointed based on the obtained network information. In an embodiment, the second network node is appointed based on the topological position information of the at least two network nodes in each of the determined groups. In an example, the second network node in a group from the N groups is appointed based on proximity to the first network node. In an example, the second network node is appointed based on reducing communication between the network nodes within a group of the N groups or within a system 200.

In S405, the system 200 is configured to inform the network nodes in each group about the appointed FL sub-manager node. In an embodiment, information such as network node ID or an IP/MAC address that identifies the FL sub-manager node is sent to the network nodes in each group. Necessary security and privacy parameters such as encryption certificates are then exchanged between the FL sub-manager node and the network nodes of a particular group.

In S406, the system 200 is configured to train an FL model in each group of the N groups using the parts of the network data accessible by the at least two network nodes wherein communication takes place between the network nodes and the FL sub-manager node of each determined group, and the FL sub-manager node of each determined group and the FL manager node 240. In other words, the system 200 is configured to train an FL model in each group of the N groups using a part of the network data accessible by each of the network nodes in each determined group.

FIG. 4B is a flowchart depicting embodiments of a method in a system 200. According to an embodiment, a system for training of an FL model in a communication network, wherein the system comprises network nodes is provided. Each network node of the network nodes having access to a part of the network data. One of the network nodes is a first network node 240. Steps S401 and S402 are performed as described for FIG. 4A.

In S403, the system 200 is configured to assign the network nodes to a group from N groups based the network information. In an embodiment of S403, the system 200 is configured to determine the number of groups and assign the network nodes to a group from the groups using a constraint-based optimization algorithm. In an embodiment, a constraint for the constraint-based optimization algorithm comprises one or more of proximity of the network nodes and the statistical properties of the data accessible by the network nodes. In an embodiment, the statistical property of the data accessible by the network nodes across different groups of the N groups should be approximately equal, that is, within a given range. In an example, the range is one or two standard deviation from a similarity/diversity average to ensure efficient learning across all the groups. In another example, the range is within 10% of the statistical property of data for each of the network nodes. In an embodiment, a number of network nodes in a group is different than a number of network nodes in another group. In other words, if we consider ‘P’ network nodes in a group ‘A’ then another group ‘B’ may have ‘Q’ network nodes. In an example, P>Q and in another example, Q>P. In an embodiment, a number of network nodes in a group is the same as a number of network nodes in another group. In other words, if group ‘C’ has ‘P’ network nodes, then group ‘D’ may also have ‘P’ network nodes. In an embodiment, a number of network nodes in each group is the same. In other words, if a system comprises groups ‘A’, ‘B’, ‘C’, then each of the groups has ‘P’ number of nodes. In an embodiment, the determination of the groups and assignment of the network nodes to each of the groups is based on a constraint-based algorithm. The constraint-based optimization algorithm may be applied to minimize network overhead in the network.

In S403-a, the system 200 is configured to perform a check to determine if each determined group of the N groups complies to a constraint if a constraint exists. In an embodiment, the constraint for the optimization algorithm comprises one or more of proximity of the network nodes and the statistical properties of the data accessible by or in the network nodes. In an example, the statistical property of the data accessible by or in the network nodes across different groups of the ‘N’ groups could be approximately equal to ensure efficient learning across all the groups. In another example, the constraint may be a similarity threshold of data accessible by a network node. In an example, the diversity threshold and the similarity threshold may be a number between 0 to 1, wherein both 0 and 1 are included. In case the constraint is met, or no constraint exists, S404-S405 as described for FIG. 4A is performed.

In S403-b, in case the constraint is not met, the system 200 is configured to compute a value representing a number of constraints of the optimization algorithm. In case the value is greater than or equal to 1, S403-c is performed wherein the system 200 is configured to remove a constraint before performing S402. If the value is less than 1 or 0, the system 200 is configured to perform S402. In an embodiment, removal of a constraint from the constraints is performed based on a rule-based engine where rules may be provided by an expert or learned using any statistical method. The system 200 is configured to perform steps S402 onward as described for FIG. 4A.

In an embodiment, the system is configured to appoint an FL sub-manager node from the network nodes in the group based on topological position information of the network node or a computational profile that minimizes network overhead within each group. If the optimization algorithm complies to the constraints, the system is configured to appoint an FL sub-manager node from the network nodes in the group based on topological position information of the network node or a computational profile that minimizes network overhead within each group. In an embodiment, the system is further configured to inform each of the network nodes in all the groups about whether the network node is an FL sub-manager node or a worker node or both. As mentioned already, the network data may be any data in the network or any data accessible by (locally or remotely) or available in the network node. In other words, the network data may be data which is not related to the network information.

Although a network node has been used in the above embodiments, a skilled person understands that the network node can also be a UE, an Internet of Things (IoT) device, a virtual machine, a cloud-computing node, an edge node, any electronic device with a network interface chip, a network management node 500, Operations Sub-System (OSS), Network Management System (NMS), a 2G/3G/4G/5G/6G network node. Also, network topology can be extracted or obtained from the NMS or OSS or any similar management node of a communication network or telecommunications operator. The NMS, OSS or any similar network management node 500 may be a 3GPP entity or may be a non-3GPP entity. The NMS, OSS or any similar network management node may also be a 3rd party entity. Another way to obtain the network topology is by a tool such as traceroute. In another example, for a fleet of cars/vehicles/automobiles/transport mode, the network topology may be obtained using actual GPS position of the cars/vehicles/automobiles/transport mode. In yet another example, the network topology could be obtained implicitly such as by analyzing handover in a telecommunications network or any other such network.

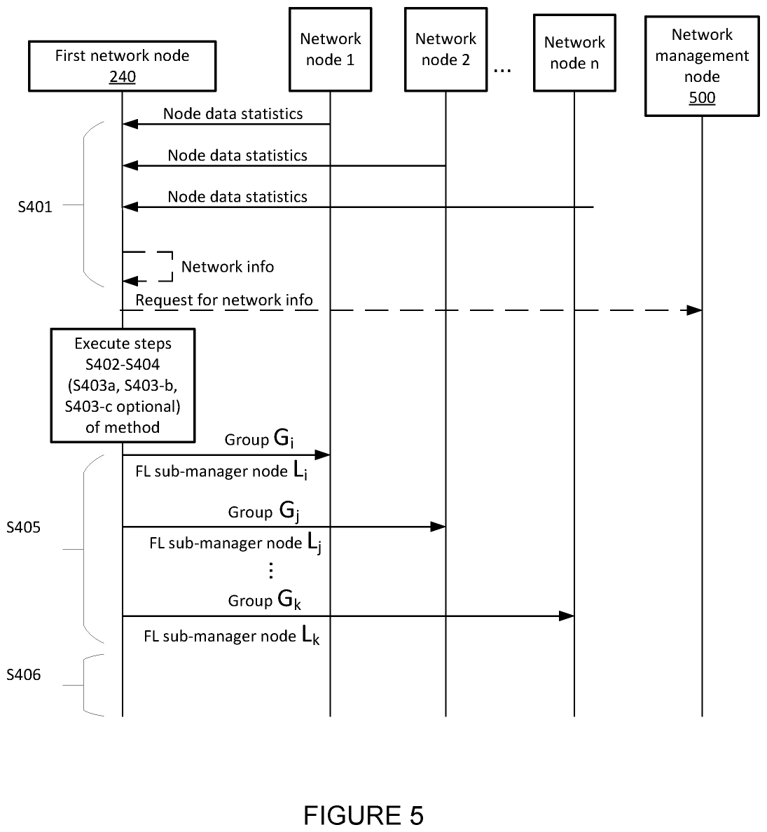

FIG. 5 illustrates signaling in a system 200 comprising network nodes, wherein one of the network nodes is a first network node 240. The signaling takes place between network nodes and the first network node 240. The first network node 240 is alternatively called the FL manager node 240. The FL manager 240 is configured to obtain/receive statistical property of network data accessible by or possessed by the network nodes 1 to ‘n’ and network information comprising a list of the network nodes and topological position information of the network nodes. The steps of obtaining networking information corresponds to S401 in FIG. 4A. In an embodiment, the first network node 240 is placed or housed in a node in the system 200 which possesses the network information. In another embodiment, the first network node 240 obtains/receives the network information from an NMS or an OSS or any similar management node in the network. The system 200 is then configured to perform steps S402, S403, S404, S405, S406 and optionally, S403-a, S403-b and S403-c.

In an embodiment, to improve network information of an FL model comprising network nodes, data accessible by or available in the network nodes may be complementary. In other words, the data collected by each network node may support the data collected by another network node for building a high-performing ML model using the FL approach.

In an embodiment, the obtained/received network information is quantified by studying data distributions of data accessible by the network nodes. In an embodiment, it is preferable to find and pair network nodes that are complementary for improving diversity of a combined data set comprising the data accessible by the network nodes. The data distributions can for example be described by, for example, Gaussian mixture models or histogram models. In an embodiment, an approach for computing a singleton measure of the diversity of the data accessible by a network node based on the concept of differential Shannon entropy is calculated as:

$$h ( X ) = - \int p ( x ) log p ( x ) dx$$

where p (x) is the probability density function for the data accessible by the network node. It is experimentally proven, albeit for transfer learning, that high-diversity data sources contribute more to the ML training process compared to low-diversity data sources.

In an embodiment, quantifying the obtained/received network information may be performed either by a data distribution based or a singleton measure approach. In an embodiment, the statistical property is based on diversity when there are a few data available or none. In such situations, the use of diversity is motivated by the fact that it is a marginal property. In other words, the statistical property does not rely on availability of data at the network node or accessible by the network node. Note that diversity is just one example of using statistics for network information.

In an embodiment, both similarity and diversity could be used for calculating the statistical property or in any other way. In an embodiment, a trade-off between diversity and similarity of the data accessible by or available in network nodes is used for determining and assigning network nodes to groups. In practice, where we don't receive/obtain sufficient data from the network nodes, similarity cannot be computed reliably. This is due to the fact that similarity is a conditional quantity/property. In contrast, diversity is a marginal quantity/property.

In an embodiment, the trade-off between using diversity and similarity as the statistical property is described by the following equation:

$$α {I}_{diversity} + ( 1 - α ) {I}_{similarity}$$

where I_{diversity} is a diversity index, I_{similarity} is a similarity index, and a is a scalar parameter between 0 and 1 which weighs the contribution of either similarity or diversity in the data accessible by the network node. In an embodiment, diversity index can be computed as an example as described in H. Larsson et al., “Source Selection in Transfer Learning for Improved Service Performance Predictions”, IFIP Networking, 2021. In an embodiment, the similarity index can be computed using Kullback Leibler divergence between a source worker and a target worker. In an embodiment, the scalar parameter a can be set by a domain expert, implying it could be either a fixed value or a variable value. In an embodiment, the scalar parameter could also be adapted through scheduling based on the availability of data wherein if there is less data available at/accessible by the network node, a higher weightage is given to the diversity index and when more data is available, higher weightage is given to the similarity index. In another embodiment, the scalar parameter could be treated as a learnable parameter in, for example, a reinforcement learning based method or other self-supervised techniques.

In an embodiment, the system 200 or the first network node 240 ensure that a minimum number of agents in each minimalistic FL group exist, in order to ensure both diversity and privacy in all groups. In an embodiment, not all the network nodes may be fully trusted, and hence only a selection of the network nodes may serve as the first network node or the FL manager node.

In an embodiment, the constraint-based optimization algorithm comprises either an evolutionary algorithm such as genetic algorithm, clustering algorithm, community detection algorithm, reinforcement learning, or an algorithm based on a divide and concur approach.

In an embodiment, the genetic algorithm approach is used for determining groups for the network nodes. In principle, the determining step can be formulated as a graph problem where vertices and edges are assigned properties corresponding to the network information. In an embodiment, the optimization algorithm finds N groups that comply to a constraint or several constraints. In one embodiment, the determination of groups is performed using a genetic algorithm framework where a chromosome, which specifies a solution to grouping of network nodes, is a vector with a length corresponding to the number of network nodes. An element in this vector is set to a number between 1 and N, corresponding to one of the possible determined groups.

One simple example of a genetic algorithm fitness function f is:

$$f = - {w}_{1} {\sum }_{G} L - {w}_{2} {\sum }_{G} {h}_{diff}$$

where L corresponds to a number of links used within each group, and h_{diff} is the difference in differential entropy between the groups. The links used within each group correspond to the physical or logical links that are present to facilitate communication between the network nodes in a particular group. The aim is to keep both sums of the number of links and the difference in differential entropy between the groups as small as possible. The two weight parameters w₁ and w₂ can be used to balance the impact of the two sums. The fitness function, f, can be extended to also cover e.g. performance of network links. The optimization algorithm then executes using cross-over, mutation, and elite operators for a population of chromosomes. For each round, the fitness function is used to prioritize the better solutions.

In an example, the network information further comprises at least one or more of: a network topology information; network resources; required Quality of Service, QoS; link utilization, latency between the network nodes; and capacity between the network nodes; and proximity of the network nodes. Network resources refers to all the physical and/or logical resources either statically or dynamically allocated to a system. QoS is the use of mechanisms or technologies that work on a system (for example, a network) to control traffic and ensure the performance of critical applications with limited network resources. QoS enables an operator or a network manager to adjust their overall network traffic by prioritizing an application or a set of applications. Link utilization refers to an amount of a value that is representative of data throughput over a link divided by data throughput capacity of a link. Latency refers to the end-to-end time taken for communication between two end points, which in this case may be two network nodes. Latency between the network nodes refers to a sum or a part of the sum of the latency between all pairs of network nodes. Proximity is either the physical or logical distance between two nodes. Proximity of the network nodes refers to a sum or a part of the sum of the proximity between all pairs of network nodes. In an example, latency and proximity between the network nodes is computed only for those links which are used for communication to and from the first network node directly and/or indirectly.

In an embodiment, a network node in a system 200 assigned to one determined group is adapted to send a model update of the trained FL model to the second network node of the determined group. In an embodiment, the first network node may act as the second network node and receive or obtain a model update from each of the network nodes in a group. The model update is sent by the network node to update a global update within each round or iteration. The model may comprise an exchange of parameters (parameters such as but not limited to number of federated learning rounds, total number of nodes used in the system 200, fraction of nodes used at each iteration for each node, local batch size used at each learning iteration, number of iterations for local training before pooling and local learning rate) between the network node and the second network node or the first network node in case the network node lies in the group with the first network node.

In an embodiment, the second network node is adapted to process the model update obtained/received from the network node to produce an output. In an example, the first network node may be adapted to process the model update obtained/received from the network node to produce an output in case the network node and the first network node belong to the same group. In an example, the output may be a shared model update or a global model update. In an example, the global model update may be sent back to each second network node and in some cases, the network node when the network node and the first network node are placed in the same group to train the FL model.

In an embodiment, a value of the statistical property of the parts of the network data accessible by the network nodes is within a given range. In an example, the given range is with one or two standard deviation from a statistical property metric. In an embodiment, a value of the statistical property of the parts of the network data accessible by the network nodes is different in the groups. In other words, the value may be different for each of the network nodes. In an embodiment, the statistical property of the parts of the network data accessible by the network nodes comprises a marginal property. In an example, the marginal property is diversity. In an embodiment, the statistical property of the parts of the network data accessible by the network nodes comprises a conditional property. In an example, the conditional property is similarity.

In an embodiment, the constraint comprises one or more of a network computational profile and a network overhead. In an example, the network computational profile is a form of dynamic process analysis in the network that measures, for example, the space (memory) or time complexity of a process in the network, overall network usage, or frequency and duration of a process in the network. The computational profile aids optimization of communication costs between the network nodes, and more specifically, minimizing costs between the network nodes. The network overhead refers to all communication except actual user data, that can include, for example, signaling data and control information.

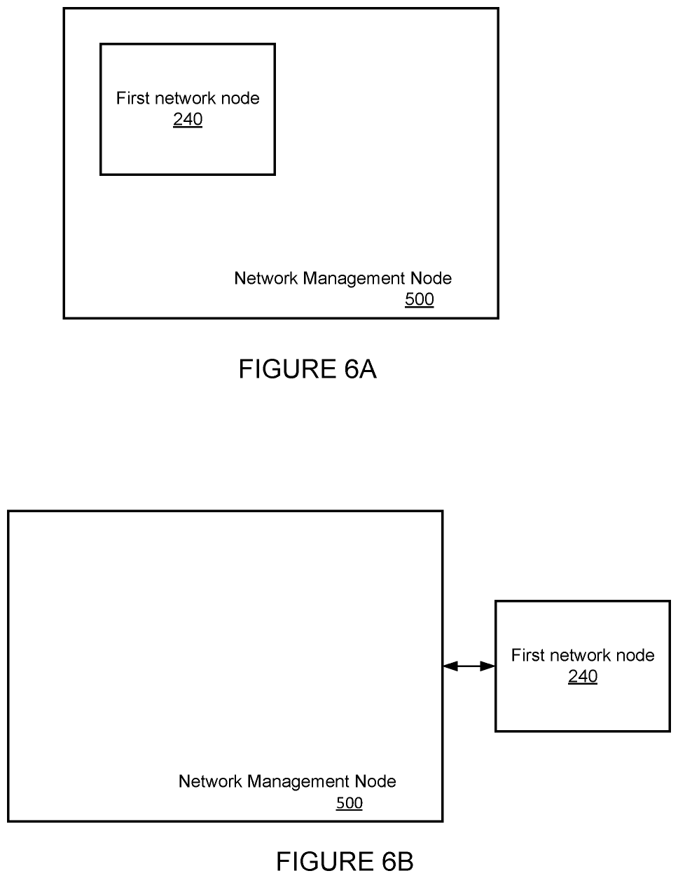

FIG. 6A illustrates an example of a first network node 240 as implemented in accordance with one or more embodiments. The network node 240 is placed or housed inside the NMS or OSS or any other similar network management node. In other words, the network node 240 is logically or physically placed inside the NMS or OSS or any other similar network management node.

FIG. 6B illustrates an example of a first network node 240 as implemented in accordance with one or more embodiments. The network node 240 is placed outside the NMS or OSS or any other similar network management node. The interaction between the network node 240 and the NMS or OSS or any other similar network management node occurs either via a wired means or a wireless means.

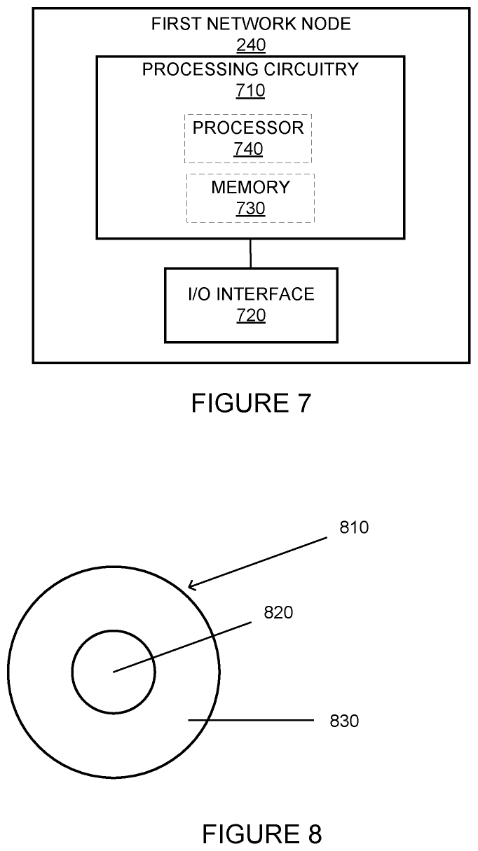

FIG. 7 illustrates an example of a first network node 240 as implemented in accordance with one or more embodiments. A processing circuitry 710 is adapted/configured/operative to cause the controller to perform a set of operations, or for example, steps, 301, 302, 303, 304, 305, 306, 306 as disclosed above, e.g., by executing instructions stored in memory 730. The processing circuitry 710 may comprise one or more of a microprocessor, a controller, a microcontroller, a central a processing unit, a digital signal processor, an application-specific integrated circuit, a field programmable gate array, or any other suitable computing device, resource, or combination of hardware, software and/or encoded logic operative to provide, either alone or in conjunction with other components of the first network node 710, such as the memory 730, in order to provide relevant functionality. The processing circuitry 710 in this regard may implement certain functional means, units, or modules. Memory 730 may include one or more non-volatile storage medium and/or one or more volatile storage medium or a cloud-based storage medium. In embodiments where processing circuitry 710 includes a programmable processor 740, a computer program product 810 may be provided in the first network node 240 or a computer program product 810 may be provided in the system 200. Such computer program product is described in relation to FIG. 8.

The memory 710 may store any suitable instructions, data, or information, including software, an application including one or more of logic, rules, code, tables, and/or other instructions/computer program code capable of being executed by the processing circuitry 710 and utilized by the first network node 240. The memory 730 may further be used to store any calculations made by the processing circuitry 710 and/or any data received via the I/O interface circuitry 720, such as input from the first network node 240 In some embodiments, the processing circuitry 710 and memory 730 are integrated.

FIG. 8 shows one example of a computer program product. Computer program product 810 includes a computer readable storage medium 830 storing a computer program 820 comprising computer readable instructions. Computer readable medium 830 of the first network node 240, may be a non-transitory computer readable medium, such as, magnetic media (e.g., a hard disk), optical media, memory devices (e.g., random access memory, flash memory), and the like. In some embodiments, the computer readable instructions of computer program 820 are configured such that when executed by processing circuitry 710, the computer readable instructions cause the first network node 240 (e.g., 301-306) or cause the system 200 to perform steps described herein (e.g., 401-406). In other embodiments, the first network node 240 may be configured/operative to perform steps described herein without the need for code. That is, for example, processing circuitry 710 may consist merely of one or more ASICs. In other embodiments, the system 200 may be adapted/configured/operative to perform steps described herein without the need for code. Hence, the features of the embodiments described herein may be implemented in hardware and/or software.

The computer program code mentioned above may also be provided, for instance in the form of a data carrier carrying computer program code for performing the embodiments herein when being loaded into the hardware. One such carrier may be in the form of a CD ROM disc. It is however feasible with other data carriers such as a memory stick. The computer program code may furthermore be provided as pure program code on a server and downloaded to the hardware device at production, and/or during software updates.

The person skilled in the art realizes that the invention by no means is limited to the embodiments described above. On the contrary, many modifications and variations are possible within the scope of the appended claims. Examples of base station include, but are not limited to, Node Bs, evolved Node Bs (eNBs), NR nodeBs (gNBs), radio access points (APs), relay nodes, remote radio head (RRH), a node in a distributed antenna system (DAS), etc. Additionally, the system described herein could be a system for autonomous vehicles, a telecommunication network, a fleet of vehicles embedded with communication modules, an industrial environment, a manufacturing plant, an appliance with multiple networking components or a combination of multiple environments.

In an embodiment, the system may be an Open Radio Access Network (O-RAN) system for next generation radio access networks. In existing implementations of O-RAN, the system herein could be implemented in an intelligent controller with nodes connected to the controller. An O-RAN system employing the method as described in the disclosure of this invention would realize the benefits of the invention such as reduced link overloading, reduced latency and faster convergence time for training.

The person skilled in the art will also appreciate that the blocks in the circuit diagram of the network node and the system may refer to a combination of analog and digital circuits, and/or one or more controllers, configured with software and/or firmware, e.g. stored in one or more local storage units, that when executed by the one or more network nodes or the first network node or the system perform the steps as described above. One or more of these network nodes or the system, as well as any other combination of analog and digital circuits, may be included in a single application-specific integrated circuitry (ASIC), or several controllers and various digital hardware may be distributed among several separate components, whether individually packaged or assembled into a system-on-a-chip (SoC). The one or more network nodes or the system may be any one of, or a combination of a central processing unit (CPU), graphical processing unit (GPU), programmable logic array (PAL) or any other similar type of circuit or logical arrangement.

1-78. (canceled)

79. A first network node configured to enable training of an FL model using network data, as part of a system comprising network nodes having access to respective parts of the network data, and wherein the first network node comprises:
an input/output interface for communicating in the system of network nodes; and
processing circuitry operatively associated with the input/output interface and configured to:
obtain network information comprising a list of the network nodes, topological position of the network nodes, and, for each network node, a statistical property of the part of the network data accessible by the network node;
determine groups of network nodes and assign each network node to one of the determined groups based on the network information, each determined group of network nodes comprising at least two network nodes; and
for each of the determined groups:
appoint a second network node as group leader from among the at least two network nodes;
inform the at least two network nodes about the appointed second network node; and
participate in training of an FL model using the parts of the network data accessible by the at least two network nodes.

80. The first network node of claim 79, wherein the processing circuitry is configured to appoint the appointed second network node based on the topological position information of the at least two network nodes.

81. The first network node according to claim 79, wherein the processing circuitry is configured to enable the appointed second network node to obtain a model update of the trained FL model from the network node.

82. The first network node according to claim 79, wherein the processing circuitry is configured to enable the appointed second network node to process the model update obtained from the network node to produce an output.

83. The first network node of claim 82, wherein the processing circuitry is configured to obtain the output from the second network node.

84. The first network node according to claim 79, wherein a number of network nodes in a group is different than a number of network nodes in another group.

85. The first network node according to claim 79, wherein a number of network nodes in a group is the same as a number of network nodes in another group.

86. The first network node according to claim 79, wherein a number of network nodes in each group is the same.

87. The first network node according to claim 79, wherein a value of the statistical property of the parts of the network data accessible by the network nodes is with a given range.

88. The first network node according to claim 79, wherein a value of the statistical property of the parts of the network data accessible by the network nodes is different in the groups.

89. The first network node according to claim 79, wherein the statistical property of the parts of the network data accessible by the network nodes comprises a marginal property.

90. The first network node according to claim 79, wherein the statistical property of the parts of the network data accessible by the network nodes comprises a conditional property.

91. The first network node according to claim 79, wherein the network information further comprises one or more of: a network topology information; network resources; required Quality of Service (QOS); link utilization, latency between the network nodes; capacity between the network nodes; proximity of the network nodes.

92. The first network node according to claim 79, adapted to set a constraint and wherein the groups are determined using the constraint.

93. The first network node according to claim 79, wherein a part of the network information is obtained from a network management node.

94. A method for enabling training of a Federated Learning, FL, model with network data, the method being performed by a first network node, the first network node configured to be part of a system comprising network nodes of which one of the network nodes is the first network node and each network node having access to a part of the network data, the method comprising:
obtaining network information comprising a list of the network nodes, topological position of the network nodes, and, for each network node, a statistical property of the part of the network data accessible by the network node;
determining groups of network nodes and assigning each network node to one of the determined groups based on the network information, each determined group of network nodes comprising at least two network nodes; and
for each of the determined groups:
appointing a second network node as group leader from among the at least two network nodes;
informing the at least two network nodes about the appointed second network node; and
participating in training of an FL model using the parts of the network data accessible by the at least two network nodes.

95. The method of claim 94, wherein the second network node for each determined group is appointed based on the topological position information of the at least two network nodes.
